(19) United States
(12) Patent Application Publication
(10) Pub. No.: US 2013/0134002 A1
(43) Pub. Date: May 30, 2013

(54) VEHICLE BRAKE ASSEMBLY

(71) Applicants: Anthony Schmandt, Walled Lake, MI (US); Paul June, Garden City, MI (US)

(72) Inventors: Anthony Schmandt, Walled Lake, MI (US); Paul June, Garden City, MI (US)

(73) Assignee: KELSEY-HAYES COMPANY, Livonia, MI (US)

(21) Appl. No.: 12/768,766

(22) Filed: Apr. 28, 2010

(51) Int. Cl. F16D 65/12

(52) U.S. Cl. 188/70 R

(57) ABSTRACT

A vehicle drum-in-hat disc brake assembly comprises a drum-in-hat adapter adapted to be secured to a fixed component of a vehicle; a backing plate adapted to be secured to the drum-in-hat adapter and to support a pair of brake shoes therein; a parking and emergency brake actuation mechanism adapted to move the brake shoes apart from another between a braking position and non-braking position, the parking and emergency brake actuation mechanism including a brake actuation lever adapted to be pivotally supported on one of the pair of brake shoes; wherein the backing plate includes at least one raised pad and the brake actuation lever includes an abutment surface provided thereon which is disposed adjacent and in sliding support with the raised pad whereby at least a portion of the abutment surface of the brake actuation lever rests against and is supported by at least a portion of the raised pad when the brake actuation lever of the parking and emergency brake actuation mechanism is in both the braking and non-braking positions.

### BACKGROUND OF THE INVENTION

This invention relates in general to vehicle drum and disc brake assemblies and in particular to an improved structure for a vehicle drum-in-hat disc brake assembly and method for producing the same.

Most vehicles are equipped with a brake system for slowing or stopping movement of the vehicle in a controlled manner. A typical brake system for an automobile or light truck includes a disc brake assembly for each of the front wheels and either a drum brake assembly or a disc brake assembly for each of the rear wheels. In some instances, the disc brake assembly can be a “drum-in-hat” type of disc brake assembly. The brake assemblies are actuated by hydraulic or pneumatic pressure generated when an operator of the vehicle depresses a brake pedal. The structures of these drum brake assemblies and disc brake assemblies, as well as the actuators therefor, are well known in the art.

A typical drum-in-hat type of disc brake assembly includes a hydraulically or pneumatically actuated disc service brake and a mechanically actuated drum-in-hat parking and emergency brake. The disc service brake includes a rotor which is secured to the wheel of the vehicle for rotation therewith. The rotor includes a pair of opposed friction plates which are selectively engaged by portions of a caliper assembly. The interior of the rotor defines a cylindrical braking surface.

A caliper assembly is slidably supported by pins secured to a mounting flange. The mounting flange is secured to a non-rotatable component of the vehicle, such as the steering knuckle or the axle flange. The caliper assembly includes a pair of brake shoes which are disposed on opposite sides of the rotor. The brake shoes are operatively connected to one or more hydraulically actuated pistons for movement between a non-braking position, wherein they are spaced apart from the opposed friction plates of the rotor, and a braking position, wherein they are moved into frictional engagement with the opposed friction plates of the rotor. When the operator of the vehicle depresses the brake pedal, the piston urges the brake shoes from the non-braking position to the braking position so as to frictionally engage the friction plates of the rotor and thereby slow or stop the rotation of the associated wheel of the vehicle.

The drum-in-hat parking and emergency brake includes a pair of opposed arcuate brake shoes which are supported on a backing plate for selective movement relative thereto. The backing plate is secured to the mounting flange, or alternatively, can be formed integral therewith. Each of the brake shoes has a friction pad or lining secured thereto. The brake shoes extend within the cylindrical braking surface of the rotor. To effect parking and emergency braking action, the operator of the vehicle manually pulls an actuating lever. The lever is connected to an actuation cable having a park brake cable end which, when pulled, actuates a mechanical actuating mechanism. The actuating mechanism can include a lever pivotally supported on one of the brake shoes. The lever is connected to actuation cable which, when pulled, is operative to move the brake shoes outwardly apart from one another such that the friction pads frictionally engage the cylindrical braking surface of the rotor. Such frictional engagement causes slowing or stopping of the rotational movement of the rotor and, therefore, the wheel of the vehicle in a controlled manner.

A typical drum brake assembly includes a backing plate which is secured to a fixed, non-rotatable component of the vehicle, such as the vehicle axle housing. A pair of opposed arcuate brake shoes are supported on the backing plate for selective movement relative thereto. Each of the brake shoes have a friction pad secured thereto. The brake drum assembly further includes a cylindrical brake drum which is secured to the vehicle wheel for rotation therewith. The interior of the brake drum is hollow, defining an inner cylindrical braking surface. The brake drum is disposed adjacent to the backing plate such that the brake shoes extend within the inner cylindrical braking surface. To effect braking action, the brake shoes are moved outwardly apart from one another such that the friction pads frictionally engage the inner cylindrical braking surface of the brake drum. Such frictional engagement causes slowing or stopping of the rotational movement of the brake drum and, therefore, the wheel of the vehicle in a controlled manner.

One or more actuating mechanisms are provided in the brake drum assembly for selectively moving the brake shoes outwardly apart from one another into frictional engagement with the cylindrical braking surface of the brake drum. Usually, a hydraulically or pneumatically actuated service brake mechanism is provided for selectively actuating the drum brake assembly under normal operating conditions. Such a service brake mechanism can include a hydraulic cylinder having a pair of opposed pistons which abut and move the brake shoes apart from one another into frictional engagement with the cylindrical braking surface of the brake drum.

A mechanically actuated parking and emergency brake mechanism is also usually provided for selectively actuating the drum brake assembly. The parking and service brake mechanism can include an actuating lever pivotally supported on one of the brake shoes. The actuating lever is connected to a cable which, when pulled, moves the brake shoes apart from one another into frictional engagement with the cylindrical braking surface of the brake drum.

### SUMMARY OF THE INVENTION

This invention relates to an improved structure for a vehicle drum-in-hat disc brake assembly and method for producing the same.

According to one embodiment, the vehicle drum-in-hat disc brake assembly comprises a drum-in-hat adapter adapted to be secured to a fixed component of a vehicle; a backing plate adapted to be secured to the drum-in-hat adapter and to support a pair of brake shoes therein; a parking and emergency brake actuation mechanism adapted to move the brake shoes apart from another between a braking position and non-braking position, the parking and emergency brake actuation mechanism including a brake actuation lever adapted to be pivotally supported on one of the pair of brake shoes; wherein the backing plate includes at least one raised pad and the brake actuation lever includes an abutment surface provided thereon which is disposed adjacent and in sliding support with the raised pad whereby at least a portion of the abutment surface of the brake actuation lever rests against and is supported by at least a portion of the raised pad when the brake actuation lever of the parking and emergency brake actuation mechanism is in both the braking and non-braking positions.

According to another embodiment, the vehicle drum-in-hat disc brake assembly comprises a drum-in-hat adapter adapted to be secured to a fixed component of a vehicle; a backing plate adapted to be secured to the drum-in-hat adapter and to support a pair of brake shoes therein; a parking and emergency brake actuation mechanism adapted to move the brake shoes apart from another between a braking position and non-braking position, the parking and emergency brake actuation mechanism including a brake actuation lever adapted to be pivotally supported on one of the pair of brake shoes; wherein the backing plate includes at least one raised pad defining an outboard facing raised pad side surface and the brake actuation lever includes an inboard facing abutment side surface provided thereon which is disposed adjacent and in sliding support with the outboard facing raised pad side surface whereby at least a portion of the inboard facing abutment side surface of the brake actuation lever rests against and is supported by at least a portion of the outboard facing raised pad side surface of the at least one raised pad when the brake actuation lever of the parking and emergency brake actuation mechanism is in both the braking and non-braking positions.

According to still a further embodiment, the vehicle drum-in-hat disc brake assembly comprises a drum-in-hat adapter adapted to be secured to a fixed component of a vehicle; a backing plate adapted to be secured to the drum-in-hat adapter and to support a pair of brake shoes therein; a parking and emergency brake actuation mechanism adapted to move the brake shoes apart from another between a braking position and non-braking position, the parking and emergency brake actuation mechanism including a brake actuation lever adapted to be pivotally supported on one of the pair of brake shoes; wherein the backing plate is a metal stamping and includes a pair of raised pads, which are formed integrally therewith during the stamping of the backing plate, and the brake actuation lever includes an abutment surface provided thereon which is disposed adjacent and in sliding support with the pair of raised pads whereby at least a portion of the abutment surface of the brake actuation lever rests against and is supported by at least a portion of the pair of raised pads when the brake actuation lever of the parking and emergency brake actuation mechanism is in both the braking and non-braking positions.

Other advantages of this invention will become apparent to those skilled in the art from the following detailed description of the invention, when read in light of the accompanying drawings.

### BRIEF DESCRIPTION OF THE DRAWINGS

FIG. 1 is a plan view of a portion of a first embodiment of a vehicle drum-in-hat disc brake assembly in accordance with the present invention.

FIG. 2 is a cross-sectional view of the first embodiment of the vehicle drum-in-hat disc brake assembly illustrated in FIG. 1 taken along line 2-2.

FIG. 3 is a plan view of selected components of the first embodiment of the vehicle drum-in-hat disc brake assembly illustrated in FIGS. 1 and 2, showing the associated brake shoes, splash shield and other selected components being removed for discussion purposes and showing the parking and emergency brake of the vehicle drum-in-hat disc brake assembly not being actuated.

FIG. 4 is a plan view of selected components of the first embodiment of the vehicle drum-in-hat disc brake assembly similar to FIG. 3 except showing the parking and emergency brake of the vehicle drum-in-hat disc brake assembly being actuated.

FIG. 5 is a perspective view of the parking and emergency brake actuating lever of the vehicle drum-in-hat disc brake assembly illustrated in FIGS. 1-4.

### DETAILED DESCRIPTION OF THE PREFERRED EMBODIMENTS

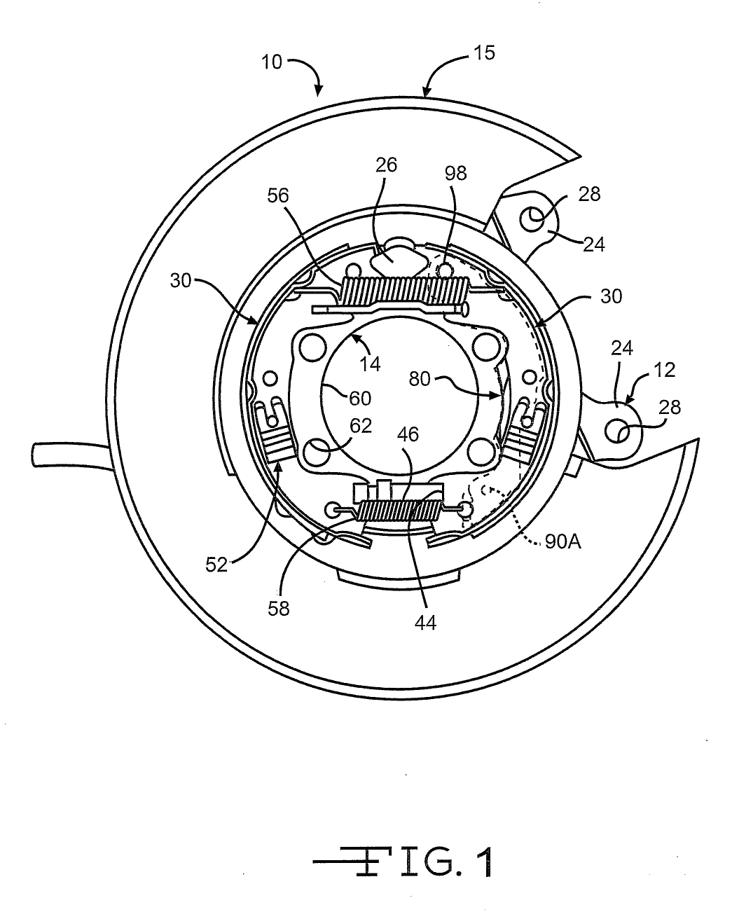

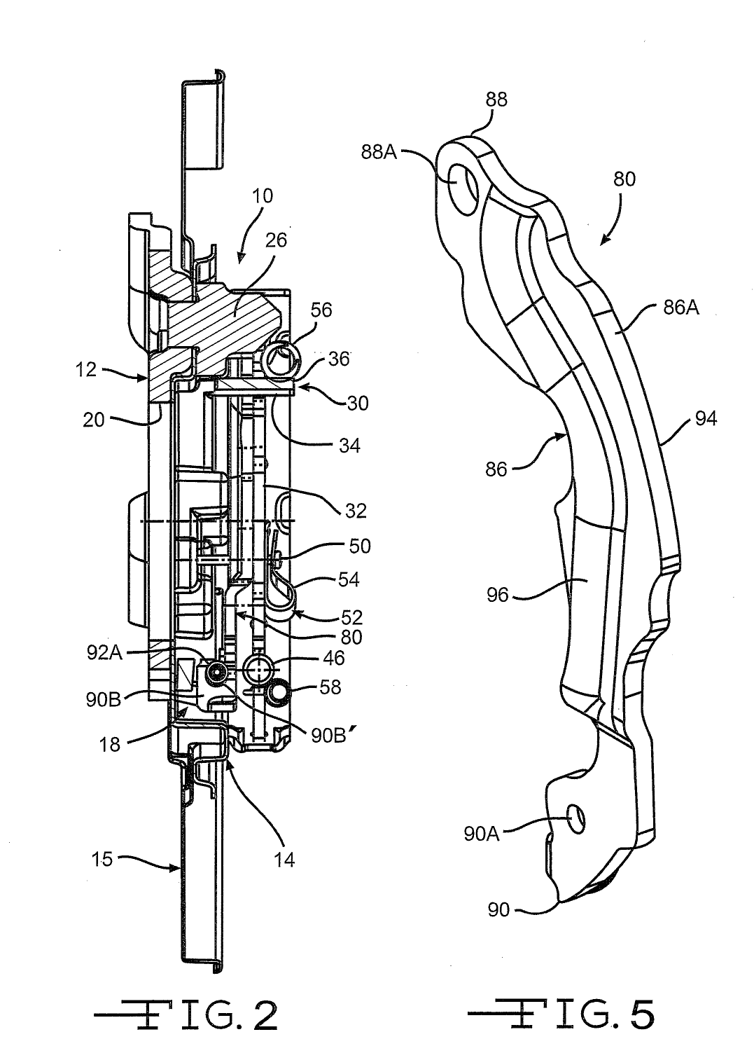

Referring now to the drawings, there is illustrated in FIGS. 1 and 2 a portion of a first embodiment of a vehicle drum-in-hat disc brake assembly, indicated generally at 10. The drum-in-hat disc brake assembly 10 includes a hydraulically or pneumatically actuated disc service brake (not shown), and a drum-in-hat parking and emergency brake. In the illustrated embodiment, the drum-in-hat parking and emergency brake is a sliding shoe type of brake. The general structure and operation of the vehicle drum-in-hat disc brake assembly 10 is conventional in the art and thus, only those portions of the vehicle drum-in-hat disc brake assembly 10 which are necessary for a full understanding of this invention will be explained and illustrated. Although the invention will be described and illustrated in connection with the particular kind of vehicle drum-in-hat disc brake assembly 10 disclosed herein, it will be appreciated that the invention may be used in connection with other kinds of drum-in-hat disc brake assembly structures which, as will be discussed below, include an “internal blade type lever” for actuating the associated brake shoes, if so desired, such as for example, as shown in U.S. Pat. No. 5,180,037 to Evans, U.S. Pat. No. 6,729,444 to Schmandt et al., and U.S. Patent Application Publication No. 2005/0145451 A1 to Kelly et al., the disclosure of each of these patent documents incorporated by reference in entirety herein. In addition, it will be appreciated that the invention may be used in connection with any other kinds of drum brake assemblies which, as will be discussed below, include an “internal blade type lever” for actuating the associated brake shoes, if so desired.

As shown in FIGS. 1 and 2, the illustrated embodiment of the drum-in-hat disc brake assembly 10 includes a drum-in-hat adapter or casting 12, a backing plate 14, an splash shield 15 (optional), a hydraulically or pneumatically actuated disc service brake (not shown), a drum-in-hat parking and emergency brake, indicated generally at 16, and a drum-in-hat parking and emergency brake actuation mechanism, indicated generally at 18 and best shown in FIG. 2. The splash shield 15 may be secured to a component of the drum-in-hat disc brake assembly 10, such as the backing plate 14, by suitable means, such as screws (not shown), if so desired.

In the illustrated embodiment, the drum-in-hat adapter 12 is adapted to be secured to a fixed, non-rotatable component of the vehicle, such as an axle flange (not shown) or a steering knuckle (not shown) for enclosing a rotatable axle (not shown). To accomplish this, the adapter 12 includes a relatively large opening 20 and a plurality of smaller holes (not shown) formed therein about the opening 20. In the illustrated embodiment, the adapter 12 has four of the smaller holes. The opening 20 permits an outer end of an axle to extend therethrough to the vehicle wheel (not shown), and suitable fasteners (not shown) are disposed in the smaller holes to secure the adapter 12 to the associated vehicle component.

The adapter 12 further includes a pair of integrally formed outwardly extending ears or lugs 24 and an abutment member 26 which can be formed integral with the adapter 12 or secured thereto by appropriate means. The ears 24 are provided with holes 28 formed therein. A pair of suitable fasteners (not shown) are disposed in the holes 28 of the ears 24 to attach a disc brake caliper assembly (not shown), which is part of hydraulically or pneumatically actuated disc service brake (not shown) of the vehicle drum-in-hat disc brake assembly 10, to the adapter 12.

The drum-in-hat parking and emergency brake portion 16 of the brake assembly 10 includes a pair of brake shoes 30 supported on the backing plate 14. Structurally, the brake shoes 30 are essentially mirror images of one another. Each of the brake shoes 30 includes a web portion 32 which is generally flat and crescent-shaped. A generally arcuate-shaped rim portion 34 is secured to the outer curved surface of the web portion 32, such as by welding. A friction pad 36 is secured to the outer arcuate surface of the rim portion 34 of the brake shoe 30.

In the illustrated embodiment, each of the brake shoes 30 includes a first end 40 and an opposite second end 42. The web portion 32 of the first end 40 of the brake shoe 30 includes a notch 44 formed therein. The notch 44 is adapted to receive an end portion of a part of a pad wear adjustment mechanism 46 in a conventional manner. In the illustrated embodiment, the second end 42 of the brake shoe 30 defines a shoe abutment end. The shoe abutment end is adapted to be received in a recess (not shown) of the abutment 26.

In the illustrated embodiment, each of the brake shoes 30 are adapted to be supported on and secured to the backing plate 14 by a pin 50 of conventional pivot pin and spring-clip assembly, indicated generally at 52. Each pin 50 is adapted to extend through an opening (not shown) provided in the backing plate 14 and through an associated opening (not shown) provided in each of the brake shoes 30. The pins 50 have outer ends which are adapted to be fastened or secured to clips 54 of the spring-clip assemblies 52 to secure the brake shoes 30 to the backing plate 14 in a conventional manner. The illustrated drum-in-hat brake assembly 10 also includes a pair of retraction springs 56 and 58. Alternatively, the structure of the brake shoes 30 may be other than illustrated if so desired.

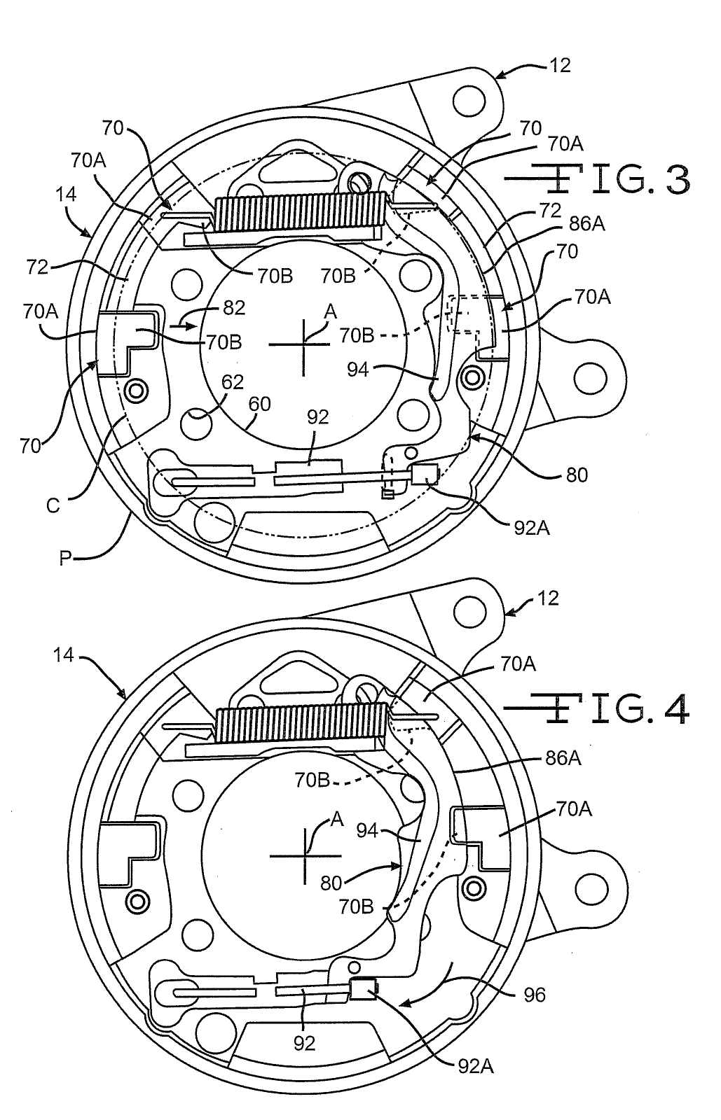

In the illustrated embodiment the backing plate 14 of the drum-in-hat disc brake assembly 10 is preferably a stamped metal backing plate and includes a relatively large central opening 60 having a plurality of smaller openings 62 formed therein about the opening 60, as best shown in FIGS. 3 and 4. In the illustrated embodiment, the backing plate 14 is provided with four of such smaller openings 62.

The central opening 60 permits an outer end of the rotatable axle (not shown) to extend therethrough to a wheel (not shown) of the vehicle. The openings 62 are adapted to allow suitable fasteners, such as threaded mounting studs (not shown), to be used to secure the backing plate 14 to the associated vehicle component. The studs extend and pass freely through the openings 62 of the backing plate 14 and the corresponding openings 22 formed in the drum-in-hat adapter 12 and nuts (not shown) are installed thereon to secure the backing plate 14 and the drum-in-hat adapter 12, and therefore the drum-in-hat disc brake assembly 10, to the associated vehicle component.

In the illustrated embodiment, the backing plate 14 further includes a plurality of raised or embossed “brake actuation lever supporting” pads or supports 70 provided thereon. In the illustrated embodiment, each of the raised pads 70 is generally L-shaped and includes a first “longer” portion or leg 70A and a second “shorter” portion or leg 70B. As can be seen best on the left hand side of FIG. 3, the pad 70 located on the upper hand portion in the drawing is slightly different in shape compared to the pad 70 located on the lower hand portion of the drawing in that a remote end of the second leg 70B has a slight taper 70B′. In the illustrated embodiment, this is because of the particular configuration of the associated components of the vehicle drum-in-hat disc brake assembly 10. However, it will be understood that the particular shape, location and/or number of one or more of the pads 70 may be other than illustrated and described if so desired.

Also, in the illustrated embodiment, the pads 70 on the right left hand and right hand sides of the backing plate 14 are essentially mirror images of one another in order to make the backing plate 14 a non-handed backing plate. However, the pads 70 can be provided only on one side of the backing plate 14, that being the side on which an actuation lever, as will be described below, is provided. Also, in the illustrated embodiment, a pair of adjacent pads 70 on the right side and the left side of the backing plate 14 are connected together by a raised or embossed arcuate “brake shoe supporting” pad or support 72 provided thereon. Each of the pads 72 is located along a circle C which is located near an outer periphery P of the backing plate. The pad 72 defines a supporting surface for the associated brake shoe 30 via the rim portion 34 thereof.

In the illustrated embodiment, the first leg 70A of each of the pads 70 extends in a direction which is generally located along the circle C of the backing plate 14. As will be discussed below, the first leg 70A of the pair of adjacent pads 70 defines a common outboard facing pad support surface for supporting both the associated brake shoe 30 (via the rim portion 34 thereof), and an “internal blade type” actuation lever 80 for actuating the parking and emergency brake mechanism 16 of the vehicle drum-in-hat disc brake assembly 10. Thus, it can be seen in the illustrated embodiment that the first legs 70A of the pair of adjacent pads 70 extend generally along the path as that of the arcuate pads 72. In the illustrated embodiment, the second leg 70B of each of the pads 70 extends in a generally radially inwardly extending direction, generally in the direction of arrow 82, toward a center axis A of the backing plate 14, for a purpose to be discussed below.

Also, in the illustrated embodiment, in order the for the first legs 70A of the pair of adjacent pads 70 to define the common outboard facing pad support surface for supporting both the associated brake shoe 30 (via the rim portion 34 thereof), a height of an outboard surface of the pads 70 is generally the same as a height of an outboard surface of the arcuate portion 72 for the purpose of supporting the rim portion 34 of the associated brake shoe 30. Alternatively, the height of the outboard surface of the pads 70 can be other than illustrated if so desired.

In addition, in the illustrated embodiment the backing plate 14 is shown as having two pads 70 on each of the opposed sides thereof. However, the backing plate 14 may have more (or less) than two of such pads 70 if so desired, although two pads 70 are preferred. Also, the particular shape of the pads 70 may be different than that illustrated and/or can be different from each other and/or the location can be other than illustrated depending upon the particular configuration of the associated components of the brake assembly 10, so long as the pads 70 provide the function or purpose discussed below.

The drum-in-hat disc brake assembly 10 further includes the actuation lever 80, best shown in FIG. 5. As shown therein, the actuating lever 80 includes an arcuate body portion 86 having a first end 88 and a second end 90. The body portion 86 includes an “inboard facing” abutment surface or lever support surface 94. Preferably, the actuation lever 80 is formed from a metal stamping and the abutment surface 86A is formed during the stamping process. In the illustrated embodiment, the abutment surface 94 is a generally flat planar “inboard facing” side surface located directly adjacent an “outer” side edge surface 86A of the actuation lever 80 extends a substantial length or distance of the body portion 86 in a curved in a unique path or configuration from generally near the first end 88 toward near the second end 90 thereof, for a purpose to be discussed below. Alternatively, the actuation lever 80 and/or the abutment surface 94 thereof may be formed by other suitable methods if so desired.

As can be seen in FIGS. 2 and 5, the abutment surface 92 is offset relative rest of the body portion 86 of the actuation lever 80 via a transition surface or portion 94. In particular, the abutment portion 92 extends in a generally first “inner” plane whereas the rest of the body portion 86 of the actuation lever 80 extends in a generally second “outer” plane which is located “outwardly” offset or non-planar relative to the first plane. Alternatively, the particular configuration of the actuation lever 80 and, in particular the abutment surface 92 thereof, may be other than illustrated if so desired so long as the function and operation thereof is as will be described below.

In the illustrated embodiment, the first end 88 of the actuation lever 80 is provided with an opening 88A and the second end 90 is provided with a raised or embossed projection 90A. The opening 88A in the first end 88 of the actuation lever 80 is adapted to receive a suitable fastener, such as a pivot pin 98 (shown in FIG. 1), which also extends through an opening (not shown) provided in the web portion 32 of the brake shoe 30, and is secured thereto by suitable means, such a suitable fastener or peening over an end thereof, to thereby pivotally secure the actuation lever 80 on the brake shoe 30 of the drum-in-hat disc brake assembly 10. Alternatively, the actuation lever 80 may be pivotally supported on the brake shoe 30 by other suitable means if so desired.

In the illustrated embodiment, the second end 90 is also provided with a leg or extension 90B (shown in FIG. 2), which extends generally perpendicular to the body portion 86, as shown in FIG. 2. The leg 90B is provided with a hooked opening 90B′ which is adapted to receive a “cable button” end 92A of a parking and emergency brake actuation cable 92 (as best shown in FIGS. 3 and 4). The actuation cable 92 may be connected to a hand operated lever or similar manually operable parking and emergency brake mechanism for manually selectively actuating the drum-in-hat disc brake assembly 10 as is known in the art. Briefly, to effect parking and emergency braking action, the actuation cable 92 is pulled causing the actuation lever 80 to pivot on the one brake shoe 30 and which is results in moving the brake shoes 30 apart from one another and into frictional engagement with an inner cylindrical braking surface of an associated brake rotor (not shown) of the drum-in-hat disc brake assembly 10. In the illustrated embodiment, the projection 90A provided in the second end 90 of the actuation lever 80 is adapted to define a lever feature detent for the end 92A of the actuation cable 92.

Turning now to FIGS. 3 and 4, the operation and function of the illustrated embodiment of the drum-in-hat disc brake assembly 10 according to the present invention will be discussed. As shown in FIG. 3 on the right hand side of the drawing, when the drum-in-hat parking and emergency brake actuation mechanism 18 is not actuated, the actuation lever 80 is in a rest or non-actuated position and is supported on the two pads 70. In particular, in the non-actuated position, the actuation lever 80 via the inboard facing abutment surface 94 is supported on one of pads 70, which is located on the upper right hand portion of FIG. 3, along portions of both of the legs 70A and 70B thereof, and on the other one of the pads 70, which is located on the lower right hand portion of FIG. 3, along a portion only the leg 70B thereof. Also, they may be portions of an opposite “outboard facing” side surface 86B of the body portion 86 of the actuation lever 80 that may be in contact with an adjacent surface of the web portion 32 of the brake shoe 30.

Next, as shown in FIG. 4, when the drum-in-hat parking and emergency brake actuation mechanism 18 is actuated, the actuation lever 80 is moved via the actuation cable and pivots in a clockwise direction as shown by arrow 96, on the brake shoe 30 to an actuated or stroked position as shown therein, and remains supported on the two pads 70. In particular, in the actuated position, the actuation lever 80 via the inboard facing abutment surface 94 is supported on the one of the pads 70, which is located on the upper right hand side of FIG. 4, along a portion of only the leg 70B thereof, and on the other one of the pads 70, which is located on the lower right hand side of FIG. 4, along a portion only the leg 70B thereof. Thus, it can be seen that the actuation lever 80, via the inboard facing abutment surface 94, remains supported at least on a portion of the two pads 70, i.e., supported on at least one of the two legs 70A and 70B of the associated two pads 70, when the actuation lever 80 is not actuated (FIG. 3), and also when the actuation lever 80 is actuated (FIG. 4). Alternatively, the particular construction or configuration of the actuation lever 80 may be other than illustrated if so desired, so long is the lever 80 remains supported at least on a portion of the two pads 70 (which as discussed above may also have a different configuration and/or location), when the actuation lever 80 is not actuated and also when the actuation lever 80 is actuated.

One advantage of the present invention is that the drum-in-hat disc brake assembly 10 fully supports the associated actuation lever 80 relative to the backing plate 14 via the pads 70 when the actuation lever 80 is not actuated and also when the actuation lever 80 is actuated to improve the mechanical efficiency of the actuation lever 80.

In accordance with the provisions of the patent statues, the principle and mode of operation of this invention have been described and illustrated in its preferred embodiments. However, it must be understood that the invention may be practiced otherwise than as specifically explained and illustrated without departing from the scope or spirit of the attached claims.

1. A vehicle drum-in-hat disc brake assembly comprising:
a drum-in-hat adapter adapted to be secured to a fixed component of a vehicle;
a backing plate adapted to be secured to the drum-in-hat adapter and to support a pair of brake shoes therein; and
a parking and emergency brake actuation mechanism adapted to move the brake shoes apart from one another between a braking position and non-braking position, the parking and emergency brake actuation mechanism including a brake actuation lever adapted to be pivotally supported on one of the pair of brake shoes;
wherein the backing plate includes at least two spaced apart raised pads each defining an outboard facing raised pad side surface and the brake actuation lever includes an inboard facing abutment side surface provided on an arcuate body portion thereof and which is located adjacent an outer side edge surface of the brake actuation lever and which extends a substantial length of the body portion in a generally curved configuration from generally near a first end of the brake actuation lever toward near a second end of the brake actuation lever, and wherein the abutment side surface is disposed adjacent and in sliding support with the outboard facing raised pad side surfaces whereby at least a portion of the inboard facing abutment side surface of the brake actuation lever rests against and is supported by at least a portion of the outboard facing raised pad side surfaces of the at least two spaced apart raised pads when the brake actuation lever of the parking and emergency brake actuation mechanism is in both the braking and non-braking positions.

2. (canceled)

3. (canceled)

4. (canceled)

5. The vehicle drum-in-hat disc brake assembly of claim 1 wherein each of the at least two raised pads is generally L-shaped.

6. The vehicle drum-in-hat disc brake assembly of claim 5 wherein each of the L-shaped pads includes a first leg and a second leg, the first leg extending in a generally circular direction and the second leg extends in a generally radially inwardly extending direction toward a center axis of the backing plate.

7. The vehicle drum-in-hat disc brake assembly of claim 6 wherein the backing plate further includes a raised brake shoe support extending between the at least two raised pads, the raised brake shoe support extending in generally circular direction and between the first legs of each of the L-shaped pads.

8. (canceled)

9. A vehicle drum-in-hat disc brake assembly comprising:
a drum-in-hat adapter adapted to be secured to a fixed component of a vehicle;
a backing plate adapted to be secured to the drum-in-hat adapter and to support a pair of brake shoes therein; and
a parking and emergency brake actuation mechanism adapted to move the brake shoes apart from one another between a braking position and non-braking position, the parking and emergency brake actuation mechanism including a brake actuation lever adapted to be pivotally supported on one of the pair of brake shoes;
wherein the backing plate includes at least two raised pads and the brake actuation lever includes an abutment surface provided on an arcuate body portion thereof and which is located adjacent an outer side edge surface of the brake actuation lever and which extends a substantial length of the body portion in a generally curved configuration from generally near a first end of the brake actuation lever toward near a second end of the brake actuation lever, and wherein the abutment surface is disposed adjacent and in sliding support with raised pads whereby at least a portion of the abutment surface of the brake actuation lever rests against and is supported by at least a portion of the raised pads when the brake actuation lever of the parking and emergency brake actuation mechanism is in both the braking and non-braking positions.

10. (canceled)

11. (canceled)

12. (canceled)

13. The vehicle drum-in-hat disc brake assembly of claim 9 wherein each of the at least two raised pads is generally L-shaped.

14. The vehicle drum-in-hat disc brake assembly of claim 13 wherein each of the L-shaped pads includes a first leg and a second leg, the first leg extending in a generally circular direction and the second leg extends in a generally radially inwardly extending direction toward a center axis of the backing plate.

15. The vehicle drum-in-hat disc brake assembly of claim 14 wherein the backing plate further includes a raised brake shoe support extending between the at least two raised pads, the raised brake shoe support extending in generally circular direction and between the first legs of each of the L-shaped pads.

16. (canceled)

17. A vehicle drum-in-hat disc brake assembly comprising:
a drum-in-hat adapter adapted to be secured to a fixed component of a vehicle;
a backing plate adapted to be secured to the drum-in-hat adapter and to support a pair of brake shoes therein; and
a parking and emergency brake actuation mechanism adapted to move the brake shoes apart from one another between a braking position and non-braking position, the parking and emergency brake actuation mechanism including a brake actuation lever adapted to be pivotally supported on one of the pair of brake shoes;
wherein the backing plate is a metal stamping and includes a pair of raised pads, which are formed integrally therewith during the stamping of the backing plate, and the brake actuation lever includes an abutment surface provided on an arcuate body portion thereof and which is located adjacent an outer side edge surface of the brake actuation lever and which extends a substantial length of the body portion in a generally curved configuration from generally near a first end of the brake actuation lever toward near a second end of the brake actuation lever, and wherein the abutment surface is disposed adjacent and in sliding support with the pair of raised pads whereby at least a portion of the abutment surface of the brake actuation lever rests against and is supported by at least a portion of the raised pads when the brake actuation lever of the parking and emergency brake actuation mechanism is in both the braking and non-braking positions.

18. The vehicle drum-in-hat disc brake assembly of claim 17 wherein each of the pair of raised pads is generally L-shaped and includes a first leg and a second leg, the first leg extending in a generally circular direction and the second leg extends in a generally radially inwardly extending direction toward a center axis of the backing plate.

19. The vehicle drum-in-hat disc brake assembly of claim 18 wherein the backing plate further includes a raised brake shoe support extending between the pair of raised pads, the raised brake shoe support extending in generally circular direction and between the first legs of each of the L-shaped pads.

20. (canceled)

21. The vehicle drum-in-hat disc brake assembly of claim 1 wherein the abutment side surface is offset relative to the body portion via a transition portion whereby the abutment side surface extends in a generally first plane whereas the body portion extends in a generally second plane which is located offset relative to the first plane.

22. The vehicle drum-in-hat disc brake assembly of claim 9 wherein the abutment surface is offset relative to the body portion via a transition portion whereby the abutment surface extends in a generally first plane whereas the body portion extends in a generally second plane which is located offset relative to the first plane.

23. The vehicle drum-in-hat disc brake assembly of claim 17 wherein the abutment surface is offset relative to the body portion via a transition portion whereby the abutment surface extends in a generally first plane whereas the body portion extends in a generally second plane which is located offset relative to the first plane.
